(19) United States
(12) Patent Application Publication
(10) Pub. No.: US 2020/0327483 A1
(43) Pub. Date: Oct. 15, 2020

(54) MANAGEMENT DEVICE, MANAGEMENT METHOD, AND MANAGEMENT PROGRAM

(71) Applicant: TOYOTA JIDOSHA KABUSHIKI KAISHA, Toyota-shi (JP)

(72) Inventors: Naoko YOSHIZAWA, Nagoya-shi (JP); Takumi FUKUNAGA, Nagoya-shi (JP); Shinichirou FUJII, Kawasaki-shi (JP); Hiromitsu FUJII, Kariya-shi (JP)

(73) Assignee: TOYOTA JIDOSHA KABUSHIKI KAISHA, Toyota-shi (JP)

(21) Appl. No.: 16/827,382

(22) Filed: Mar. 23, 2020

(30) Foreign Application Priority Data
Apr. 11, 2019 (JP) 2019-075733

(51) Int. Cl. G06Q 10/08; G08G 1/00

(52) U.S. Cl. CPC G06Q 10/083; G08G 1/202

(57) ABSTRACT

A management device includes a memory and a processor having at least one piece of hardware. The processor is configured to determine whether a schedule can be changed based on the information on a package to be collected or delivered when a schedule change request is received from a client terminal or a provider terminal. The client terminal is associated with a client of a delivery of a package, and the provider terminal is associated with a provider of a vehicle which is parked or stopped in a predetermined area and the vehicle cabin of which is provided as a collection/delivery place of the package. Then, the processor sends a determination result to the sending terminal of the schedule change request.

### INCORPORATION BY REFERENCE

The disclosure of Japanese Patent Application No. 2019-075733 filed on Apr. 11, 2019 including the specification, drawings and abstract is incorporated herein by reference in its entirety.

### BACKGROUND

### 1. Technical Field

The present disclosure relates to a management device, a management method, and a management program.

### 2. Description of Related Art

There is a technique in which, for use when a deliveryman collects and delivers packages, the trunk of a typical passenger car, registered in advance as a package receiving vehicle, is used as the reception/delivery position for a delivery package (for example, see Japanese Unexamined Patent Application Publication No. 2006-206225 (JP 2006-206225 A)). In this technique, when collecting and delivering packages, the authentication processing is performed between the collection/delivery communication device of a collection/delivery company and the vehicle communication device mounted on a specified vehicle and, when the authentication is successful, the trunk of the specified vehicle can be locked and unlocked.

### SUMMARY

However, the technique disclosed in JP 2006-206225 A described above does not consider how to deal with a situation in which the schedule of a client of package collection/delivery or the schedule of the provider of a package receiving vehicle is changed.

The present disclosure provides a management device, a management method, and a management program that can deal appropriately with a situation in which the schedule of a client of package collection/delivery or the schedule of the provider of a package receiving vehicle is changed.

A management device according to the present disclosure includes a memory and a processor having at least one piece of hardware. The processor is configured to determine whether a schedule can be changed based on package information when a schedule change request is received from a client terminal or a provider terminal, wherein the client terminal is associated with a client of a delivery of a package and the provider terminal is associated with a provider of a vehicle which is parked or stopped in a predetermined area and the vehicle cabin of which is provided as a collection/delivery place of the package and, then, to send a determination result to a sending terminal of the schedule change request.

When the schedule change request is received from one of the provider terminal and the client terminal, the processor may be configured to send an inquiry as to whether the schedule can be changed to the other terminal and to determine whether the schedule can be changed by further using a response to the inquiry received from the other terminal.

This configuration determines whether the schedule can be changed considering the intention of a provider or a client who has not sent a schedule change request, thus making it possible to provide a more flexible service.

The processor may be configured to select a transfer candidate vehicle of the package based on the package information and parking/stopping information, to inquire of a candidate terminal as to whether the package can be transferred and, when a transfer acceptance response is received from the candidate terminal, to determine that the schedule can be changed, wherein the parking/stopping information includes information on parking/stopping of a plurality of vehicles each of which can provide a vehicle cabin thereof for receiving other person's packages in the area and the candidate terminal is associated with a provider of the selected transfer candidate vehicle.

This configuration allows a package to be transferred in response to a schedule change request when a plurality of package receiving vehicles parked or stopped in the predetermined area are registered. Thus, this configuration ensures the effective use of the vehicles registered as package receiving vehicles in the predetermined area, making it possible to deal appropriately with a schedule change request from a client or a provider.

The processor may be configured to select the transfer candidate vehicle by further referring to schedule information registered by providers of the plurality of vehicles.

This configuration allows an appropriate vehicle to be selected according to the schedule of the provider of a vehicle and prevents a transfer error that occurs when the vehicle is not present in the area.

The memory may be configured to store past transfer history information and the processor may be configured to select the transfer candidate vehicle by further referring to the history information.

This configuration allows the transfer candidate vehicle to be efficiently selected considering the history information on past transfers.

The processor may be configured to select the transfer candidate vehicle according to a type of the package.

This configuration allows an appropriate vehicle to be selected according to the type of the package.

When a transfer acceptance notification is received from the candidate terminal, the processor may be configured to send a transfer instruction to a deliveryman terminal associated with a deliveryman of the package, wherein the transfer instruction includes information on the transfer candidate vehicle.

This configuration sends the transfer instruction to the deliveryman terminal to allow the transfer information to be transmitted reliably to the deliveryman.

A management method according to the present disclosure is a management method performed by a management device including a memory and a processor having at least one piece of hardware. The management method includes determining whether a schedule can be changed by reading package information from the memory when a schedule change request is received from a client terminal or a provider terminal, wherein the client terminal is associated with a client of a delivery of a package and the provider terminal is associated with a provider of a vehicle which is parked or stopped in a predetermined area and the vehicle cabin of which is provided as a collection/delivery place of the package, and sending a determination result to a sending terminal of the schedule change request.

A management program according to the present disclosure is a management program that causes a management device including a memory and a processor having at least one piece of hardware to execute determining whether a schedule can be changed based on package information when a schedule change request is received from a client terminal or a provider terminal, wherein the client terminal is associated with a client of a delivery of a package and the provider terminal is associated with a provider of a vehicle which is parked or stopped in a predetermined area and the vehicle cabin of which is provided as a collection/delivery place of the package, and sending a determination result to a sending terminal of the schedule change request.

According to the present disclosure, when a schedule change request is received from a client terminal associated with the client of the delivery of a collection/delivery package or from a provider terminal associated with the provider of a vehicle that is provided as the collection/delivery place of the package, the management device determines whether the schedule can be changed based on the information about the package and sends the determination result to the sending terminal of the schedule change request to accurately notify the schedule change requesting person about the information including whether the schedule can be changed. Therefore, a schedule change, which is requested by a client of package collection/delivery or the provider of a packet receiving vehicle, can be dealt with appropriately.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a diagram showing an outline of a collection/delivery system that includes a management device according to a first embodiment;

FIG. 2 is a block diagram showing a functional configuration of the collection/delivery system that includes the management device according to the first embodiment;

FIG. 3 is a diagram schematically showing package information stored in the management device according to the first embodiment;

FIG. 4 is a sequence diagram showing an outline of processing performed by the collection/delivery system that includes the management device according to the first embodiment;

FIG. 5 is a sequence diagram showing an outline of processing performed by a collection/delivery system that includes a management device according to a modification of the first embodiment;

FIG. 6 is a diagram showing a functional configuration of a collection/delivery system that includes a management device according to a second embodiment;

FIG. 7 is a diagram schematically showing parking/stopping information stored in the management device according to the second embodiment;

FIG. 8 is a sequence diagram showing an outline of processing (first example) performed by the collection/delivery system that includes the management device according to the second embodiment;

FIG. 9 is a diagram schematically showing updated parking/stopping information (first example) stored in the management device according to the second embodiment;

FIG. 10 is a sequence diagram showing an outline of another processing (second example) performed by the collection/delivery system that includes the management device according to the second embodiment; and

FIG. 11 is a diagram schematically showing updated parking/stopping information (second example) stored in the management device according to the second embodiment.

### DETAILED DESCRIPTION OF EMBODIMENTS

A mode in which the present disclosure is carried out (hereinafter referred to as “embodiment”) will be described with reference to the accompanying drawings.

### First Embodiment

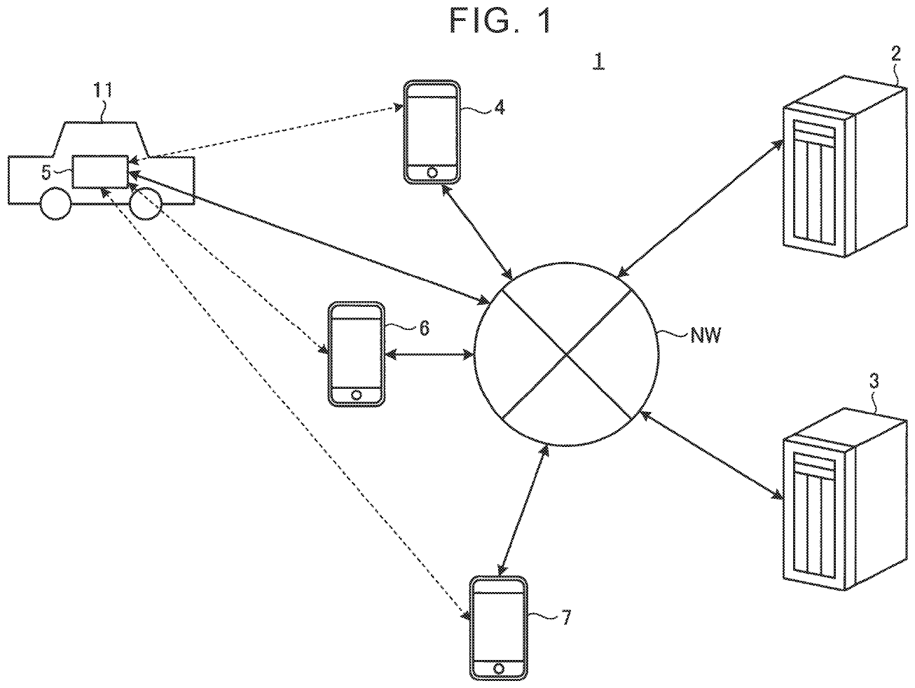

FIG. 1 is a diagram showing an outline of a collection/delivery system that includes a management device according to a first embodiment. A collection/delivery system 1 shown in FIG. 1 is a system in which the vehicle cabin of a vehicle 11, which is parked or stopped in a predetermined area and is registered in advance as a package receiving vehicle, is used to collect or deliver a package. The vehicle cabin of the vehicle 11 is the trunk or the boarding space of the vehicle 11. The area is a closed area such as a parking lot where the vehicle 11 is parked, but is not limited thereto.

The collection/delivery system 1 includes a management device 2 that manages the collection/delivery of packages, a center server 3 that manages the opening and closing of the doors of the vehicle 11, a deliveryman terminal 4 associated with a deliveryman, an in-vehicle device 5 mounted on the vehicle 11, a client terminal 6 associated with the collection/delivery client of a package, and a provider terminal 7 associated with a provider who owns the vehicle 11 and provides the vehicle cabin for receiving a package. The management device 2, center server 3, deliveryman terminal 4, in-vehicle device 5, client terminal 6, and provider terminal 7 are connected to the communication network NW for communicating with each other. In addition, the deliveryman terminal 4, client terminal 6, and provider terminal 7 are communicably connected to the in-vehicle device 5 via short-range wireless communication. The communication network NW is one of a local area network (LAN), a wide area network (WAN), a public network, a virtual private network (VPN), or a leased line or a combination of them. The communication network NW is configured by a combination of a network using wired communication and a network using wireless communication. Examples of short-range wireless communication standards include Bluetooth (registered trademark) low energy (BLE), near field communication (NFC), ultra wideband (UWB), and WiFi (registered trademark).

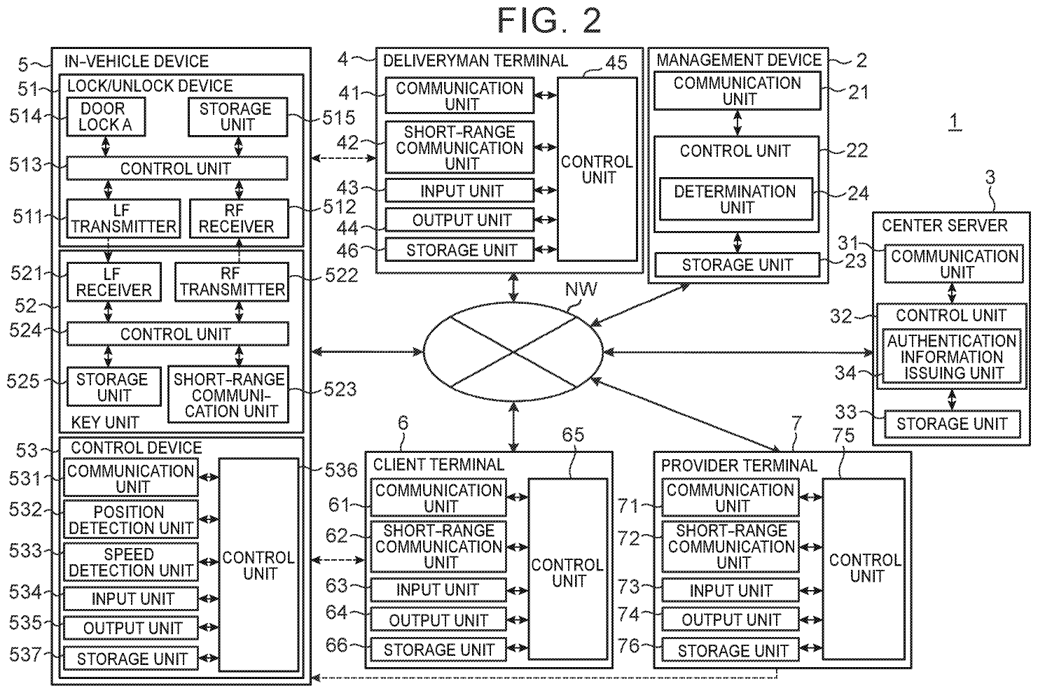

FIG. 2 is a block diagram showing a functional configuration of the collection/delivery system 1. A functional configuration for each component of the collection/delivery system 1 will be described below.

<Management Device 2>

The management device 2 includes a communication unit 21, a control unit 22, and a storage unit 23.

The communication unit 21 is an interface that communicates with the center server 3, deliveryman terminal 4, client terminal 6, and provider terminal 7 via the communication network NW.

The control unit 22 has a determination unit 24. When a schedule change request is received from the client terminal 6 associated with the package delivery client or from the provider terminal 7 associated with the provider of the vehicle 11, the determination unit 24 determines whether the schedule can be changed based on the information related to the collection/delivery package and sends the determination result to the sending terminal of the schedule change request.

The control unit 22 is a processor configured by a piece of hardware alone or by a combination of pieces of hardware. The hardware is a general-purpose processor such as a central processing unit (CPU) or a dedicated integrated circuit that performs a specific function such as a field programmable gate array (FPGA). The control unit 22 reads various programs from the storage unit 23 to perform various types of arithmetic processing for operating the management device 2.

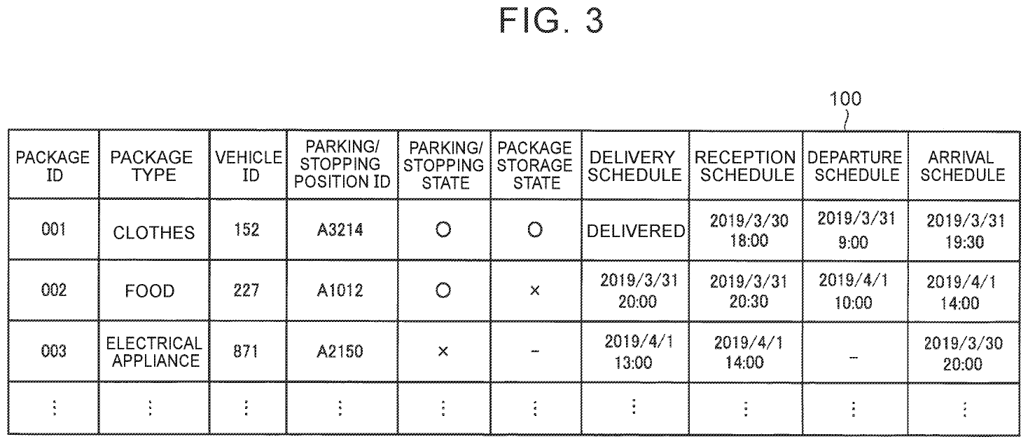

The storage unit 23 stores the information on collection/delivery packages (hereinafter referred to as package information). FIG. 3 is a diagram schematically showing the package information stored in the storage unit 23. The table 100 shown in the figure includes, for each vehicle, the package ID, package type, collection/delivery vehicle ID, parking/stopping position ID, parking/stopping state, package storage state, package delivery schedule, package reception schedule, and departure and arrival schedule of the vehicle 11. The parking/stopping state is updated based on the position information sent from the in-vehicle device 5. The delivery schedule and the reception schedule are registered based on the information sent from the client terminal 6. The departure schedule and arrival schedule are registered based on the schedule information sent from the provider terminal 7. For example, the type of the package with the package ID 001 is clothes and this package is delivered to the vehicle cabin of the vehicle 11 with the vehicle ID 152 (hereinafter referred to as the vehicle 152). This vehicle 152 is parked/stopped at the position indicated by the parking/stopping position ID A3214 and a package is currently stored in its vehicle cabin. The reception schedule of the package in the vehicle 152 is at 18:00 on Mar. 30, 2019. Furthermore, the vehicle 152 is scheduled to leave the parking/stopping position at 9:00 on Mar. 31, 2019 and arrive at the parking/stopping position at 19:30 on the same day. The parking/stopping information may be stored, not in the storage unit 23, but in a device other than the management device 2.

The storage unit 23 further stores various programs for performing the operation of the management device 2. The various programs include the management program that, when the management device 2 receives a schedule change request from the client terminal 6 or the provider terminal 7, determines whether the schedule can be changed and sends the determination result to the terminal that has sent the schedule change request.

The storage unit 23 is configured by a volatile memory such as a random access memory (RAM) and a nonvolatile memory such as a read only memory (ROM). The storage unit 23 may also be configured by a computer-readable recording medium such as a memory card that can be externally mounted. Various programs stored in the storage unit 23 can be recorded on a computer-readable recording medium, such as a hard disk, a flash memory, a CD-ROM, a DVD-ROM, or a flexible disk, for broader distribution.

<Center Server 3>

The center server 3 is an authentication management device that manages the authentication information used to authenticate a plurality of vehicles 11. The center server 3 includes a communication unit 31, a control unit 32, and a storage unit 33.

The communication unit 31 is an interface that communicates with the management device 2 via the communication network NW.

The control unit 32 has an authentication information issuing unit 34. The authentication information issuing unit 34 issues the authentication information for locking or unlocking the vehicle 11. When an authentication information issuance request for locking or unlocking the vehicle 11 is received from the deliveryman terminal 4 or the client terminal 6 via the management device 2, the authentication information issuing unit 34 sends the authentication information, corresponding to a key unit 52, back to the deliveryman terminal 4 or the client terminal 6 via the management device 2. The authentication information issuing unit 34 may generate authentication information including the information on an expiration date.

The control unit 32 is a processor configured by a piece of hardware alone such as a CPU or FPGA or by a combination of them. The control unit 32 reads various programs from the storage unit 33 to perform various types of arithmetic processing for operating the center server 3.

The storage unit 33 stores the information necessary for the authentication information issuing unit 34 to issue authentication information and various programs for performing the operations of the center server 3. The storage unit 33 is configured by a RAM, a ROM, and the like.

<Deliveryman Terminal 4>

The deliveryman terminal 4 includes a communication unit 41, a short-range communication unit 42, an input unit 43, an output unit 44, a control unit 45, and a storage unit 46. The deliveryman terminal 4, which is a terminal associated with a deliveryman of a package, is a carried by the deliveryman. The deliveryman terminal 4 is configured, for example, by a smartphone, a mobile phone, a tablet terminal, a personal information terminal, a wearable computer, or the like.

The communication unit 41 is an interface that communicates with at least the management device 2 via the communication network NW.

The short-range communication unit 42 is an interface that performs short-range wireless communication with the in-vehicle device 5. The short-range communication unit 42 performs short-range wireless communication based on any of the above-mentioned standards such as BLE, NFC, UWB, and WiFi (registered trademark).

The input unit 43 is configured by a user interface such as a keyboard, buttons, levers, a touch panel provided on the display that serves as the output unit 44, and a microphone for voice input. The input unit 43 accepts an input of various types of information.

The output unit 44 is configured by a display for displaying information using a liquid crystal display or organic electro luminescence (EL) display, a speaker for voice output, and the like.

The control unit 45 controls the operation of the deliveryman terminal 4. The control unit 45 is a processor configured by a piece of hardware alone such as a CPU or FPGA or by a combination of them. The control unit 45 reads various programs from the storage unit 46 to perform various types of arithmetic processing for operating the deliveryman terminal 4.

The storage unit 46 stores various programs for performing the operations of the deliveryman terminal 4. The storage unit 46 is configured by a RAM, a ROM, and the like.

The deliveryman terminal 4 may further include a capturing unit configured by an image sensor such as a CCD or a CMOS. In this case, the deliveryman uses the deliveryman terminal 4 to capture the vehicle cabin and send the captured image data to the management device 2. Based on the received image data, the management device 2 performs image recognition to recognize whether there is a space in the vehicle cabin for receiving a package.

In addition, an application that displays the parking/stopping information on the vehicle 11 may be provided as an application downloadable by the deliveryman terminal 4.

<In-Vehicle Device 5>

The in-vehicle device 5 is mounted on the vehicle 11. The in-vehicle device 5 includes a lock/unlock device 51, the key unit 52, and a control device 53. The in-vehicle device 5 performs a series of processing for locking or unlocking the vehicle 11 as follows: that is, the in-vehicle device 5 receives the authentication information from the deliveryman terminal 4, client terminal 6, or provider terminal 7, performs the authentication processing through the key unit 52 based on the received authentication information, and activates the lock/unlock device 51. In addition, the control device 53 of the in-vehicle device 5 detects the position and the movement state of the vehicle 11 and sends the detected information to the management device 2 via the communication network NW. An expiration date is included in the authentication information sent from the deliveryman terminal 4 and the client terminal 6. In other words, the deliveryman terminal 4 and the client terminal 6 need to obtain the authentication information from the center server 3 for each collection/delivery of a package. On the other hand, the provider terminal 7 stores the master authentication information with no expiration date.

The lock/unlock device 51 is a device for locking or unlocking the doors of the vehicle 11. The lock/unlock device 51 includes an LF transmitter 511, an RF receiver 512, a control unit 513, a door lock actuator 514, and a storage unit 515. In FIG. 2, the door lock actuator is indicated as “door lock A”.

The LF transmitter 511 sends a radio wave in a low frequency band (for example, 100 KHz to 300 KHz) for searching for (polling) the key unit 52. The LF transmitter 511 is built, for example, near the center console or the steering wheel in the vehicle cabin.

The RF receiver 512 receives radio waves (lock/unlock signal) in a high frequency band (for example, 100 MHz to 1 GHz) sent from the key unit 52. The RF receiver 512 is installed anywhere in the vehicle cabin.

The control unit 513 compares the key ID, included in the lock/unlock signal received from the key unit 52, with the key ID stored in the storage unit 515. When it is determined that the received key ID is valid, the control unit 513 sends the signal to the door lock actuator 514 to lock or unlock the doors of the vehicle 11 whose vehicle cabin is used for receiving a package.

The control unit 513 is configured by a piece of hardware alone such as a CPU or FPGA or by a combination of them. The control unit 513 may be configured by a plurality of electric control units (ECUs) connected communicably to each other via a vehicle network such as a controller area network (CAN). In the description below, the lock signal and the unlock signal are sometimes collectively referred to as the lock/unlock signal.

The door lock actuator 514 is an actuator that locks or unlocks the doors of the vehicle 11. The door lock actuator 514 operates based on the lock/unlock signal sent from the control unit 513. The door lock actuator 514 may lock and unlock each door of the vehicle 11 independently. For example, when the trunk is used as the vehicle cabin for receiving a package, the door lock actuator 514 may lock/unlock only the trunk.

The storage unit 515 stores various information including the key ID of the vehicle door and various programs for operating the lock/unlock device 51. The storage unit 515 is configured by a RAM, a ROM, and the like.

The key unit 52 includes an LF receiver 521, an RF transmitter 522, a short-range communication unit 523, a control unit 524, and a storage unit 525. The key unit 52 is arranged in a predetermined position, for example, in the glove box in the vehicle cabin of the vehicle 11.

The LF receiver 521 receives the polling signal sent from the lock/unlock device 51 via radio waves in a low frequency band. The LF receiver 521 has an antenna (hereinafter referred to as LF antenna) for receiving radio waves in a low frequency band.

The RF transmitter 522 sends the lock/unlock signal to the lock/unlock device 51 via radio waves in a high frequency band.

The short-range communication unit 523 is a communication interface that performs short-range wireless communication with the deliveryman terminal 4, the client terminal 6, or the provider terminal 7.

The control unit 524 controls the operation of the key unit 52. The control unit 524 compares the authentication information, included in a lock request or an unlock request received from the deliveryman terminal 4, the client terminal 6, or the provider terminal 7, with the authentication information stored in the storage unit 525. When these pieces of authentication information are in a predetermined relationship, it is determined that the authentication is successful. The predetermined relationship here refers to one of the following three relationships: (1) a relationship in which the authentication information stored in the storage unit 525 matches the authentication information received from the deliveryman terminal 4, the client terminal 6, or the provider terminal 7, (2) a relationship in which the results of predetermined encryption/decryption processing for the two pieces of authentication information match, and (3) a relationship in which the result of decryption processing for one of the two pieces of authentication information matches that for the other piece of authentication information.

When the deliveryman terminal 4, the client terminal 6, or the provider terminal 7 is successfully authenticated, the control unit 524 sends the lock/unlock signal, generated in response to the request received from the deliveryman terminal 4, the client terminal 6, or the provider terminal 7, to the lock/unlock device 51 via the RF transmitter 522.

The control unit 524 is configured by a piece of hardware alone such as a CPU or FPGA or by a combination of them.

The storage unit 525 stores the authentication information for authenticating the deliveryman terminal 4, the client terminal 6, or the provider terminal 7, as well as the key ID. The storage unit 525 may store an encrypted key ID. When the storage unit 525 stores an encrypted key ID, the control unit 524 receives the decryption information from the deliveryman terminal 4, the client terminal 6 or the provider terminal 7 and, based on the received decryption information, decrypts the key ID.

The storage unit 525 stores various programs for performing the operation of the key unit 52. The storage unit 525 is configured by a RAM, a ROM, and the like. In the description below, the authentication information stored in the storage unit 525 is sometimes referred to as the device authentication information, and the authentication information sent by the deliveryman terminal 4, the client terminal 6 or the provider terminal 7 is sometimes referred to as the terminal authentication information.

The key unit 52 having the configuration described above communicates with the lock/unlock device 51 of the in-vehicle device 5, making it possible to lock and unlock the vehicle 11 without using a physical key.

The control device 53 includes a communication unit 531, a position detection unit 532, a speed detection unit 533, an input unit 534, an output unit 535, a control unit 536, and a storage unit 537.

The communication unit 531 is an interface that communicates with the management device 2 via the communication network NW. The communication unit 531 sends the position information and speed information on the vehicle 11 to the management device 2.

The position detection unit 532 is configured, for example, by a global positioning system (GPS) sensor that receives GPS signals sent by the GPS satellites. Based on the received signals, the position detection unit 532 detects the position information (including latitude and longitude) on the vehicle 11 and outputs the detected position information to the control unit 536. Note that, as a method for detecting the position information on the vehicle 11, the position detection unit 532 may employ a method in which LiDAR (Light Detection and Ranging, Laser Imaging Detection and Ranging) and a three-dimensional digital map are combined.

The speed detection unit 533 is configured, for example, by a vehicle speed sensor. The speed detection unit 533 detects the information on the speed of the vehicle 11 and outputs the detected speed to the control unit 536.

The position detection unit 532 and the speed detection unit 533 may detect the position information and the speed information via mobile communication that conforms to the communication standard such as 3G, 4G, 5G, or Long Term Evolution (LTE). In this case, the position information and the speed information may be detected via mobile communication with other vehicles, with various sensors provided around the road on which the vehicle is traveling, and with the server that acquires the information from these vehicles and various sensors.

The input unit 534 and the output unit 535 have the functional configuration similar to that of the input unit 43 and the output unit 44 described above. The input unit 534 can also accept an input of schedule information on the vehicle 11 from the provider of the vehicle 11. The schedule information on the vehicle 11 mentioned here includes the date and time when the vehicle 11 leaves the area and the date and time when the vehicle 11 arrives at the area. The schedule information may include the information on whether the vehicle cabin of the vehicle 11 that is parked or stopped in the area can be used for storing a package.

The control unit 536 controls the operation of the control device 53. The control unit 536 is a processor configured by a piece of hardware alone such as a CPU or FPGA or by a combination of them. The control unit 536 reads various programs from the storage unit 537 to perform various types of arithmetic processing for operating the control device 53.

The storage unit 537 stores various types of information including the detection results detected by the position detection unit 532 and the speed detection unit 533 and various programs for performing the operation of the control device 53. The storage unit 537 is configured by a RAM, a ROM, and the like.

The in-vehicle device 5 may further include an in-vehicle camera or a weight sensor as a unit for confirming whether there is a space in the vehicle cabin for receiving a package. In this case, the in-vehicle device 5 sends the image data, captured by the in-vehicle camera, to the management device 2. Based on the received image data, the management device 2 performs image recognition to recognize whether there is a space in the vehicle cabin for receiving a package. The in-vehicle camera may capture the image only while the vehicle cabin key is unlocked.

Furthermore, a reader that can read the information recorded on a recording medium (such as a two-dimensional code) may be provided in the vehicle cabin. In this case, a recording medium, which is read by the reader, is attached to the packaging material of a package. When a package is stored in a predetermined position in the vehicle cabin, this configuration allows the reader to read the information recorded on the recording medium and send the information to the management device 2 to notify that the package has been stored in the vehicle cabin.

<Client Terminal 6>

The client terminal 6 has a functional configuration similar to that of the deliveryman terminal 4. More specifically, the client terminal 6 includes a communication unit 61, a short-range communication unit 62, an input unit 63, an output unit 64, a control unit 65, and a storage unit 66. The functional configurations of the communication unit 61, short-range communication unit 62, input unit 63, output unit 64, control unit 65, and storage unit 66 are similar to those of the communication unit 41, short-range communication unit 42, and input unit 43, output unit 44, control unit 45, and storage unit 46, respectively.

<Provider Terminal 7>

The provider terminal 7 has a functional configuration similar to that of the deliveryman terminal 4. More specifically, the provider terminal 7 includes a communication unit 71, a short-range communication unit 72, an input unit 73, an output unit 74, a control unit 75, and a storage unit 76. The functional configurations of the communication unit 71, short-range communication unit 72, input unit 73, output unit 74, control unit 75, and storage unit 76 are similar to those of the communication unit 41, short-range communication unit 42, input unit 43, output unit 44, control unit 45, and storage unit 46, respectively. The input unit 73, one of those units, accepts an input of schedule information on the vehicle 11 from the provider of the vehicle 11. The storage unit 76 stores the master authentication information that can be authenticated by the key unit 52. Therefore, the provider can use the provider terminal 7 to lock and unlock the vehicle 11 at any time.

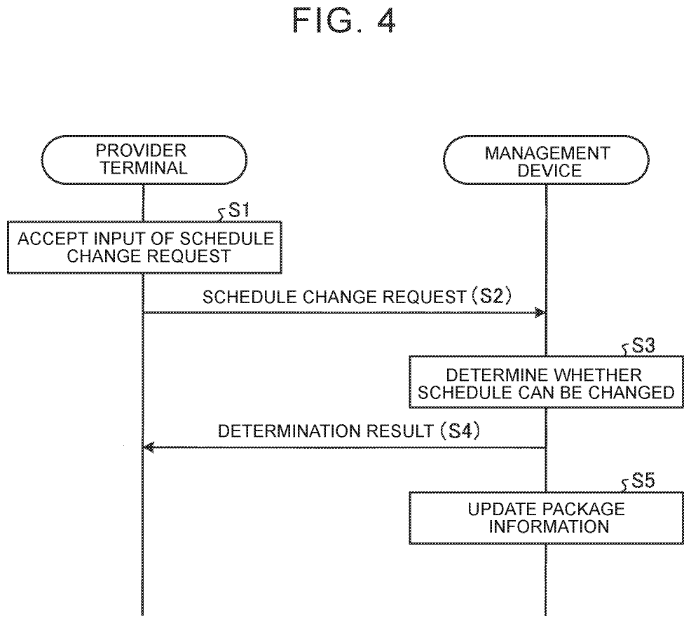

FIG. 4 is a sequence diagram showing an outline of processing of the collection/delivery system 1 in which the provider of the vehicle 11 requests a schedule change. FIG. 4 shows an outline of processing in which the provider of the vehicle 11 storing a package therein requests a schedule change and it is determined that the schedule can be changed.

First, when the input unit 73 of the provider terminal 7 accepts an input of a schedule change request from a provider (step S1), the communication unit 71 sends the schedule change request to the management device 2 under the control of the control unit 75 (step S2). The schedule change request includes, for example, a change in at least one of the departure schedule and arrival schedule of the vehicle 11.

In the management device 2 that has received the schedule change request, the determination unit 24 refers to the package information to determine whether the schedule can be changed (step S3). For example, when the provider terminal 7 associated with the provider of the vehicle 152 sends a request to change the departure schedule to 7:00 on Mar. 31, 2019, the determination unit 24 refers to the table, shown in FIG. 3, and confirms that the departure schedule is later than the package reception schedule at which the client receives the package (18:00 on Mar. 30, 2019) and therefore determines that the schedule can be changed.

After that, the communication unit 21 of the management device 2 sends the determination result to the provider terminal 7 under the control of the control unit 22 (step S4). For example, when the schedule change request is sent from the provider of the vehicle 152 as described above, the communication unit 21 sends the determination result, which indicates that the schedule can be changed, to the provider terminal 7.

After that, the control unit 22 updates the package information stored in the storage unit 23 (step S5). When the result of the determination by the determination unit 24 indicates that the schedule cannot be changed, the control unit 22 does not update the package information.

When the client of package delivery uses the client terminal 6 to send a schedule change request to the management device 2, the processing described above is performed with the provider terminal 7 replaced with the client terminal 6. In this case, the schedule change request sent by the client terminal 6 includes, for example, a change in the reception schedule.

According to the first embodiment described above, when a schedule change request is received from a client terminal associated with the client of the delivery of a collection/delivery package or from a provider terminal associated with the provider of a vehicle that is provided as the collection/delivery place of the package, the management device determines whether the schedule can be changed based on the information about the package and sends the determination result to the sending terminal of the schedule change request to accurately notify the schedule change requesting person about the information including whether the schedule can be changed. Therefore, a schedule change, which is requested by a client of package collection/delivery or the provider of a packet receiving vehicle, can be dealt with appropriately.

According to the first embodiment, a person who does not own a vehicle can also use the vehicle cabin of a vehicle and, at the same time, a person who owns but rarely uses a vehicle can effectively use the vehicle.

(Modification)

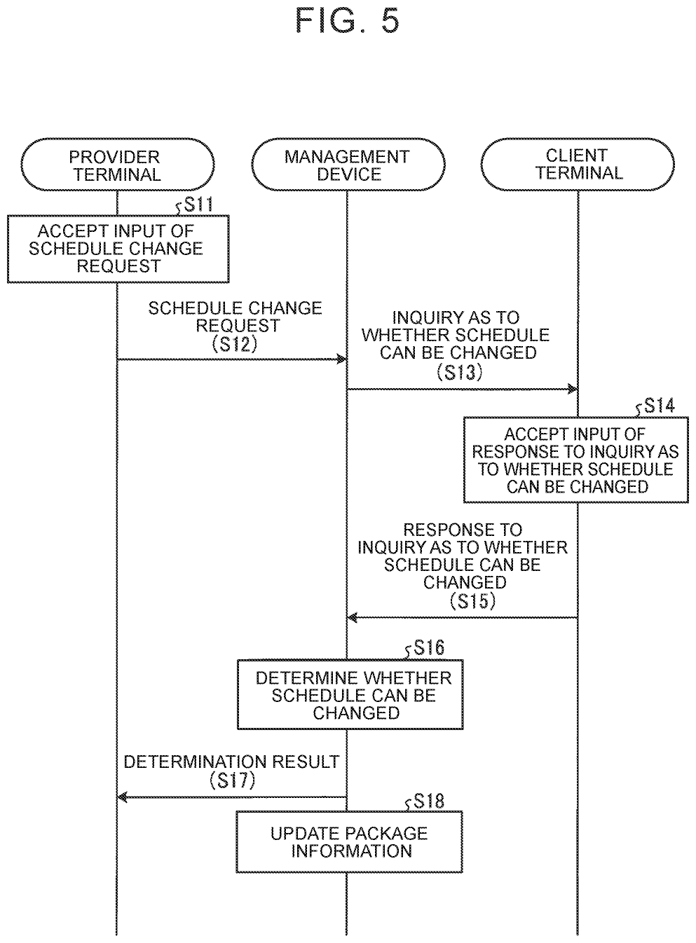

FIG. 5 is a sequence diagram showing an outline of processing of the collection/delivery system 1 when the provider of the vehicle 11 requests a schedule change. FIG. 5 shows an outline of processing performed for one vehicle 11 (for example, vehicle 001 described above) that is parked or stopped with a package stored in the vehicle cabin.

The processing in steps S11 and S12 is the same as the processing in steps S1 and S2 described above.

After step S12, under the control of the control unit 22, the communication unit 21 of the management device 2 sends an inquiry as to whether the schedule can be changed (step S13) to the client terminal 6.

In the client terminal 6 that has received the inquiry as to whether the schedule can be changed, the input unit 63 accepts an input of a response to the inquiry as to whether the schedule can be changed (step S14) from the client. After that, under the control of the control unit 65, the communication unit 61 sends, to the management device 2, the response to the inquiry as to whether the schedule can be changed (step S15).

In the management device 2 that has received the response to the inquiry as to whether the schedule can be changed, the determination unit 24 determines whether the schedule can be changed by referring to the response and to the package information (step S16). When the received response indicates that the schedule cannot be changed, the determination unit 24 may determine that the schedule cannot be changed without referring to the package information.

The processing in steps S17 and S18 is the same as that in steps S4 and S5 described above. In this case, too, when the result of the determination by the determination unit 24 indicates that the schedule cannot be changed, the control unit 22 does not update the package information.

When a schedule change request is received from the client terminal 6, the management device 2 sends an inquiry, which is an inquiry as to whether the schedule can be changed, to the provider terminal 7. Then, by referring to the response from the provider terminal 7 and to the package information, the determination unit 24 determines whether the schedule can be changed.

According to the modification of the first embodiment described above, the collection/delivery system 1 determines whether the schedule can be changed considering the intention of a provider or a client who has not sent a schedule change request, thus making it possible to provide a more flexible service.

### Second Embodiment

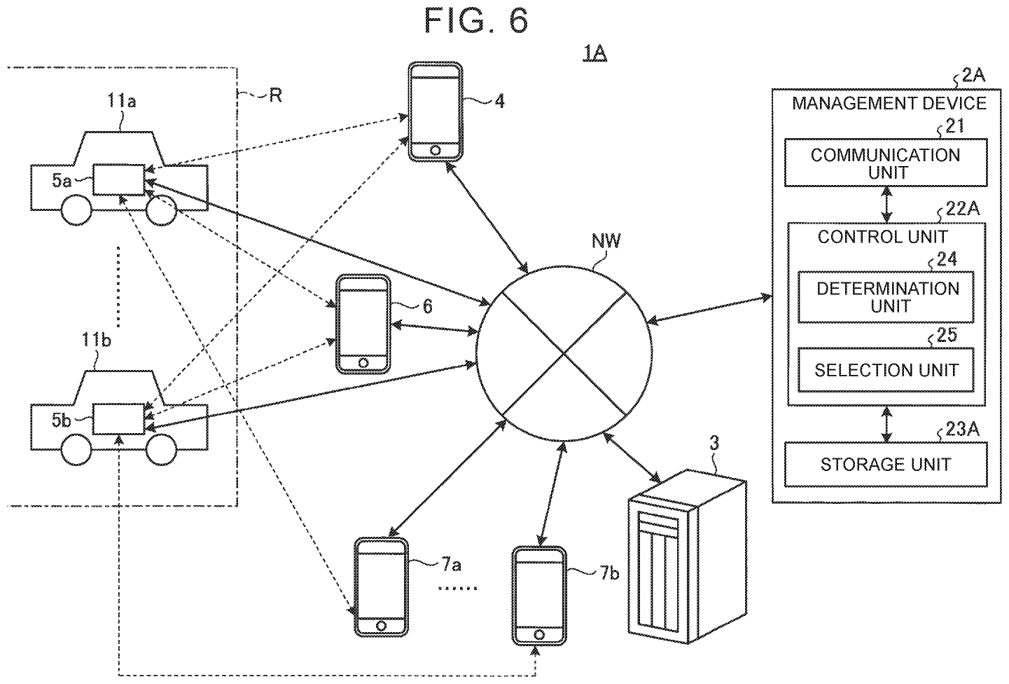

FIG. 6 is a diagram showing a functional configuration of a collection/delivery system that includes a management device according to a second embodiment. In FIG. 6, a management device 2A is shown as a block diagram. A collection/delivery system 1A shown in FIG. 6 is a system in which packages are collected/delivered using the vehicle cabins of a plurality of vehicles 11. These vehicles 11 are parked or stopped in a predetermined area R and are registered in advance as package receiving vehicles. The area R is an area including but not limited to a closed area, such as a parking lot where a plurality of vehicles 11 registered in advance are parked.

The collection/delivery system 1A includes the management device 2A, a center server 3, a deliveryman terminal 4, a plurality of in-vehicle devices 5 each mounted on one of the plurality of vehicles 11, a client terminal 6, and a plurality of provider terminals 7 associated with a plurality of providers. Each of the plurality of providers has one of the plurality of vehicles 11 and provides its vehicle cabin for receiving a package.

In the description below, two of the plurality of vehicles 11 are referred to as vehicles 11a and 11b to distinguish the two vehicles, and the in-vehicle devices mounted on the vehicles 11a and 11b are referred to as in-vehicle devices 5a and 5b, respectively. The provider terminals associated with the in-vehicle devices 5a and 5b are referred to as provider terminals 7a and 7b, respectively. Furthermore, the components of the provider terminal 7a are referred to as a communication unit 71a and so on, and the components of the provider terminal 7b are referred to as a communication unit 71b and so on.

The management device 2A includes a communication unit 21, a control unit 22A, and a storage unit 23A. The control unit 22A includes a determination unit 24 and a selection unit 25. The selection unit 25 selects a vehicle to be used for the collection/delivery of a collection/delivery package based on the parking/stopping information. The parking/stopping information includes the information on the parking/stopping positions and the parking/stopping periods of a plurality of vehicles 11 which can be parked or stopped in the area R and whose vehicle cabins can be provided for receiving packages and the information on a package to be delivered to each of the vehicles 11. In addition, in response to a schedule change request from the provider terminal 7, the selection unit 25 selects the vehicle 11 that is parked in the same area R and is a candidate for the transfer destination.

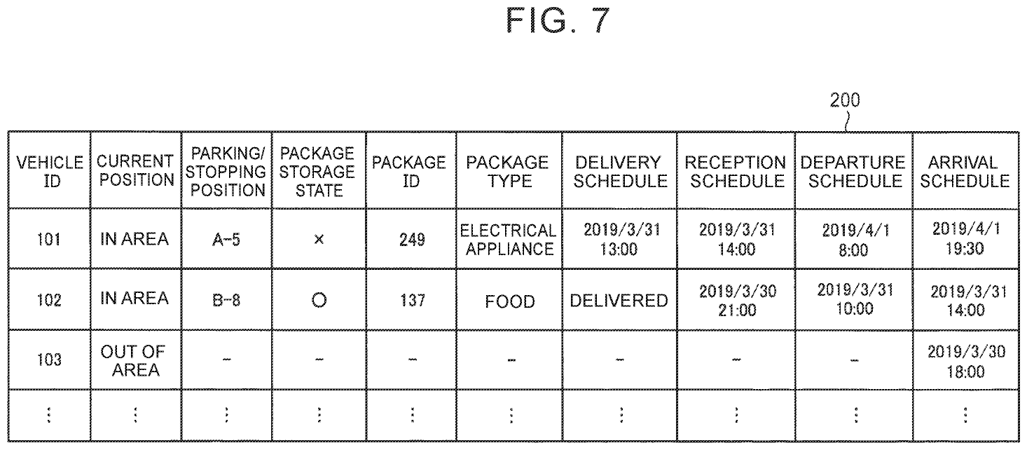

FIG. 7 is a diagram schematically showing the parking/stopping information stored in the storage unit 23A. A table 200 shown in the figure includes, for each vehicle, the collection/delivery vehicle ID, current position, parking/stopping position in the area R, package storage state, package ID, package type, package delivery schedule, package reception schedule, departure schedule, and arrival schedule. The current position and the parking/stopping position are registered based on the position information sent from the in-vehicle device 5. The delivery schedule and the reception schedule are registered based on the information sent from the client terminal 6. The departure schedule and the arrival schedule are registered based on the schedule information sent from the provider terminal 7. For example, in the vehicle cabin of the vehicle 11 with the vehicle ID 102 (hereinafter referred to as vehicle 102), the package with the package ID 137 has been delivered. The type of this package is food. The vehicle 102 is parked/stopped at the position B-8 in the area R, and the package reception schedule of the client is 21:00 on Mar. 30, 2019. The vehicle 102 is scheduled to leave the area R at 10:00 on Mar. 31, 2019 and arrive at the area R at 14:00 on the same day. The parking/stopping information may be stored, not in the storage unit 23A, but in a device other than the management device 2A.

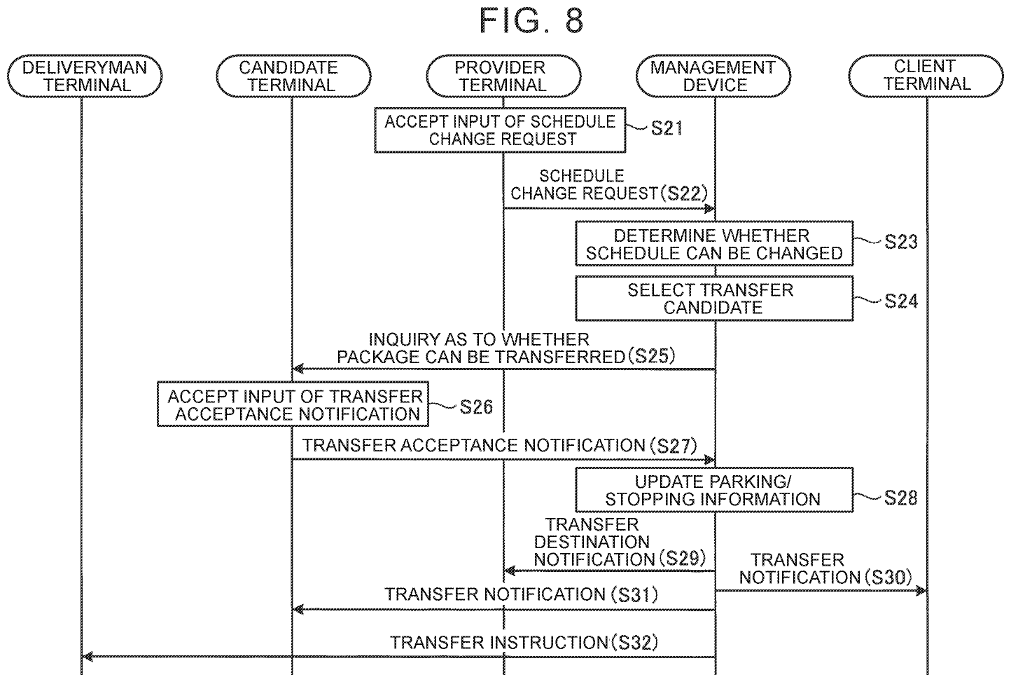

FIG. 8 is a sequence diagram showing an outline of processing performed by the collection/delivery system 1A. FIG. 8 shows an outline of processing in which a provider requests a schedule change and the requested schedule change is accomplished by transferring a delivered package. In the description below, the vehicle owned by a provider who requests a schedule change is the vehicle 11a.

First, when the input unit 73a of the provider terminal 7a accepts an input of a schedule change request for a package from the provider (step S21), the communication unit 71a sends the schedule change request to the management device 2A under the control of the control unit 75a (step S22).

In the management device 2A that has received the schedule change request, the determination unit 24 determines whether the schedule can be changed (step S23). The following describes the processing that is performed when the determination unit 24 determines that schedule can be changed. In this case, the selection unit 25 reads the parking/stopping information on a plurality of the vehicles 11, which are parked or stopped in the region R, from the storage unit 23A and, based on the parking/parking information and the schedule change request, selects a transfer candidate vehicle (step S24). In the description below, the selected transfer candidate vehicle is referred to as the vehicle 11b. The provider of the vehicle 11b is referred to as a “candidate”, and the provider terminal 7b is referred to as a “candidate terminal 7b”.

Next, the communication unit 21 sends an inquiry as to whether the package can be transferred, under the control of the control unit 22A, to the candidate terminal 7b corresponding to the vehicle 11b selected by the selection unit 25 (step S25).

When the input unit 73b of the candidate terminal 7b accepts an input of the transfer acceptance notification from the candidate (step S26), the communication unit 71b sends the transfer acceptance notification to the management device 2A (step S27).

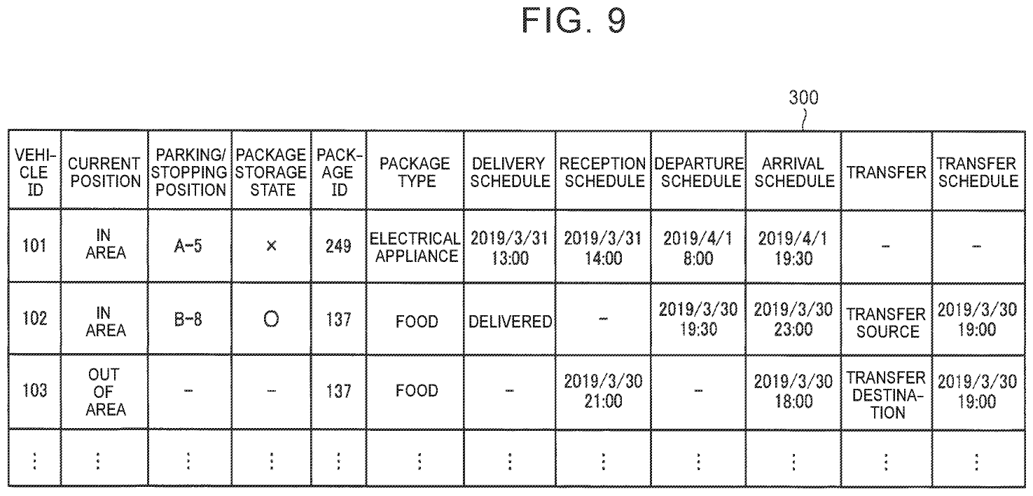

The management device 2A that has received the transfer acceptance notification updates the parking/stopping information (step S28). FIG. 9 is a diagram schematically showing the updated parking/stopping information. A table 300 shown in the figure is obtained by updating the parking/stopping information in the table 200 shown in FIG. 7. More specifically, the table 300 has two additional columns, “transfer” and “transfer schedule”. In the table 300, the vehicle ID of the transfer source vehicle 11a is 102, the vehicle ID of the transfer destination vehicle 11b is 103, and the transfer schedule is 19:00 on Mar. 30, 2019. The table 300 is updated from the table 200 in such a way that the reception schedule field of the vehicle 11a is left blank and the reception schedule field of the vehicle 11b includes the schedule that is 21:00 on Mar. 30, 2019. In the table 300, the departure schedule of the vehicle 11a is changed to 19:30 on Mar. 30, 2019, and the arrival schedule to 23:00 on Mar. 30, 2019.

After step S28, under the control of the control unit 22, the communication unit 21 sends the transfer destination notification to the provider terminal 7a (step S29), sends the transfer notification to the client terminal 6 and the candidate terminal 7b (steps S30 and S31), and sends the transfer instruction to the deliveryman terminal 4 (step S32). Note that steps S29 to S32 may be performed in any order.

After that, the deliveryman moves the package, stored in the vehicle cabin of the vehicle 11a, to the vehicle cabin of the vehicle 11b according to the transfer instruction. After the package is moved and the vehicle 11b is locked, the communication unit 41 of the deliveryman terminal 4 sends the transfer completion notification, accepted by the input unit 43, to the management device 2A. After that, the control unit 22A of the management device 2A updates the parking/sopping information, stored in the storage unit 23A, and causes the communication unit 21 to send the transfer completion report to the client terminal 6, the provider terminal 7a and the candidate terminal 7b.

When it is determined as a result of the determination in step S23 that the schedule cannot be changed, the management device 2A sends a response to the provider terminal 7a indicating that the schedule cannot be changed.

In the description above, a delivered package is transferred to another vehicle 11. On the other hand, when the management device 2A receives a schedule change request from the provider terminal 7 before the package is delivered, the selection unit 25 reselects the vehicle 11 to be used as a package collection/delivery place.

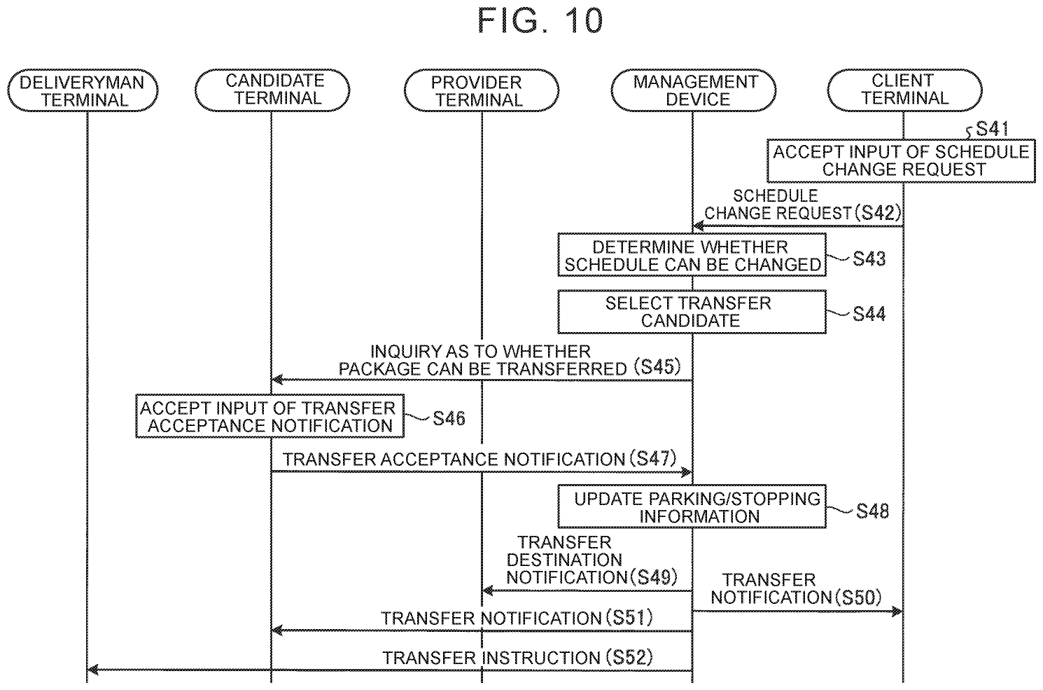

FIG. 10 is a sequence diagram showing an outline of another processing performed by the collection/delivery system 1A. FIG. 10 shows an outline of processing in which a client requests a schedule change before the delivery of a package and the requested schedule change is accomplished by changing the delivery destination of the package.

First, when the input unit 63 of the client terminal 6 accepts an input of a schedule change request for a package from the client (step S41), the communication unit 61 sends the schedule change request to the management device 2A under the control of the control unit 65 (step S42).

In the management device 2A that has received the schedule change request, the determination unit 24 determines whether the schedule can be changed (step S43). The following describes the processing that is performed when the determination unit 24 determines that schedule can be changed. The selection unit 25 reads the parking/stopping information on a plurality of the vehicles 11, which are parked or stopped in the region R, from the storage unit 23A and, based on the parking/parking information and the schedule change request, selects a transfer candidate vehicle (step S44). In the description below, the transfer source vehicle is referred to as the vehicle 11a, and the selected transfer destination candidate vehicle is referred to as the vehicle 11b. In this example, too, the provider of the vehicle 11b is referred to as a “candidate”, and the provider terminal 7b is referred to as a “candidate terminal 7b”.

Next, the communication unit 21 sends an inquiry as to whether the package can be transferred, under the control of the control unit 22A, to the candidate terminal 7b corresponding to the vehicle 11b selected by the selection unit 25 (step S45).

When the input unit 73b of the candidate terminal 7b accepts an input of the transfer acceptance notification from the candidate (step S46), the communication unit 71b sends the transfer acceptance notification to the management device 2A (step S47).

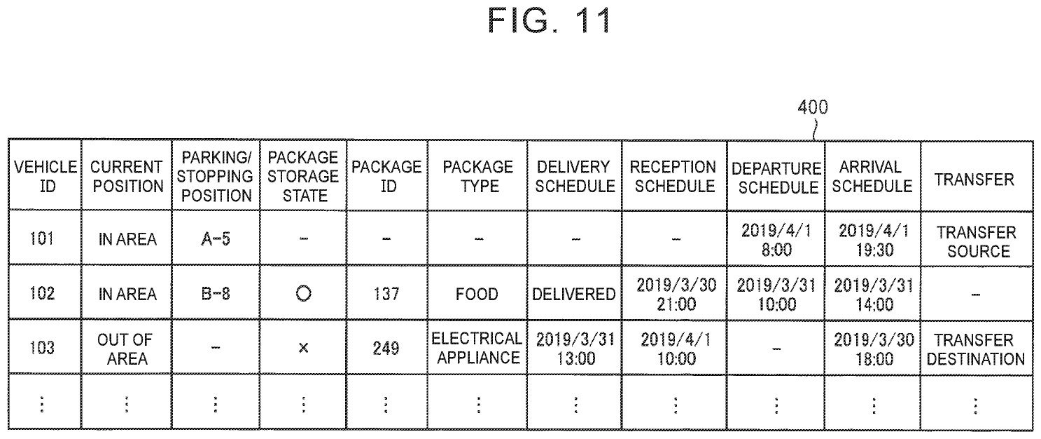

The management device 2A that has received the transfer acceptance notification updates the parking/stopping information (step S48). FIG. 11 is a diagram schematically showing the updated parking/stopping information. A table 400 shown in the figure is obtained by updating the parking/stopping information in the table 200 shown in FIG. 7 according to the schedule change request from the client. More specifically, the table 400 has one additional column “transfer”. In the table 400, the vehicle ID of the transfer source vehicle 11a is 101 and the vehicle ID of the transfer destination vehicle 11b is 103. In the table 400, the client's schedule for package reception at the vehicle 11b is 10:00 on Apr. 1, 2019, which has been changed from the original client's schedule for package reception at the vehicle 11a (14:00 on Mar. 31, 2019). In this case, the management device 2A determines that the vehicle 11a will have already departed from the region R at the client-desired time scheduled for reception and, therefore, selects the vehicle 11b that will be parked in the region R at the changed reception scheduled time.

After step S48, under the control of the control unit 22, the communication unit 21 sends the transfer destination notification to the provider terminal 7a (step S49), sends the transfer notification to the client terminal 6 and the candidate terminal 7b (steps S50 and S51), and sends the transfer instruction to the deliveryman terminal 4 (step S52). Note that steps S49 to S52 may be performed in any order.

After that, the deliveryman delivers the package to the vehicle cabin of the vehicle 11b according to the transfer instruction.

In the processing described above, the delivery destination of a package is changed according to a schedule change request received from the client terminal 6. Note that, when it is possible to change the schedule without changing the delivery destination of the package, the processing in steps S44 to S47 is not performed. In this case, the management device 2A updates the parking/stopping information and, then, sends the schedule change completion notification to the deliveryman terminal 4, the client terminal 6, and the provider terminal 7 corresponding to the vehicle 11 that is the delivery destination.

When a schedule change request is received from the client terminal 6, an inquiry as to whether the schedule can be changed may be first sent to the provider terminal 7a that is set as the package delivery destination. In this case, when a response indicating that the schedule can be changed is received from the provider terminal 7a, the parking/stopping information is updated and then the schedule change is notified to the client terminal 6. On the other hand, when a response indicating that the schedule cannot be changed is received from the provider terminal 7a, an inquiry as to whether the package can be transferred is sent to the candidate terminal 7b as described above.

When the determination unit 24 determines that schedule cannot be changed, the management device 2A sends the determination result to the client terminal 6.

The second embodiment described above can deal appropriately with a situation in which the storage time limit of a package approaches.

The second embodiment can deal appropriately with a situation in which the schedule of the provider of a vehicle or the schedule of a client of package collection/delivery is changed as in the first embodiment.

The second embodiment allows a package to be transferred in response to a schedule change request when a plurality of package receiving vehicles parked or stopped in the predetermined area are registered. Thus, this embodiment ensures the effective use of the vehicles registered as package receiving vehicles in the predetermined area, making it possible to deal appropriately with a schedule change request from a client or a provider.

The selection unit 25 may select the vehicle 11 to which a package is to be transferred by further referring to the information on the collection and delivery conditions registered in advance for each vehicle 11. Examples of the collection and delivery conditions include conditions such as the package type, package weight, and package collection/delivery time zone.

In addition, with the past transfer history information stored in the storage unit 23A, the selection unit 25 may refer to the transfer history information together with the parking/stopping information to select the vehicle 11 to which a package is to be transferred, for example, in the order of the number of times the vehicles 11 are selected as the transfer destination.

When multiple packages can be stored in one vehicle cabin, the storage unit 23A may store in advance a combination of package types that can be stored simultaneously so that the selection unit 25 can select the vehicle of the transfer destination based on the combination. For example, this prevents a situation in which a food material that is the source of odor and clothes into which the odor of the food should not preferably be absorbed are stored simultaneously in the same vehicle cabin.

Some rewards may be given to the vehicle 11 of a transfer destination. This encourages the provider of the vehicle 11 to accept a package transfer more actively.

### Other Embodiments

The embodiments have been described above, but the present disclosure should not be limited only to the first and second embodiments described above. For example, in some cases, a change request is received that requests to drive a vehicle when the vehicle stores a package therein but the package is not yet received. In such a case, the management device may determine whether the vehicle may be driven according to the type of the package. More specifically, when the package does not have any problem with driving (such as clothes), the management device allows the vehicle to be driven. On the other hand, when the package is specified as a fragile item, the management device prevents the vehicle from being driven until the reception is completed or transfers the package to another transfer candidate vehicle parked or stopped in the same area. For example, the control operation for preventing the vehicle from being driven is to lock the engine or to temporarily disable master authentication by the provider terminal.

In a predetermined area where a plurality of vehicles are registered as package receiving vehicles, when the engine of a vehicle to which a package is to be delivered is turned on before the delivery of a package, the management device may automatically change the delivery destination by selecting another vehicle. In this case, when there is no vehicle candidate to which the delivery destination can be changed, the management device sends a cancel notification or a reception-schedule resetting prompting notification to the client terminal.

The management device may be configured to have an authentication information issuing unit to perform the function of the authentication management device.

Instead of a collection/delivery system with one management device and one center server, the edge computing technique may be applied. The edge computing technique allows terminals, each capable of performing a part of the processing of the management device and the center server, to be distributed and arranged physically close to deliveryman terminals, making it possible to send and receive large amounts of data efficiently and to reduce the processing time.

Further effects and modifications can be easily derived by those skilled in the art. The broader aspects of the present disclosure are not limited to the specific details and the typical embodiments expressed and described above. Accordingly, various modifications can be made without departing from the spirit or scope of the general inventive concept as defined by the appended claims and their equivalents.

What is claimed is:

1. A management device comprising:
a memory; and
a processor having at least one piece of hardware, wherein
the processor is configured to determine whether a schedule can be changed based on package information when a schedule change request is received from a client terminal or a provider terminal, the client terminal being associated with a client of a delivery of a package, the provider terminal being associated with a provider of a vehicle which is parked or stopped in a predetermined area and the vehicle cabin of which is provided as a collection/delivery place of the package; and
send a determination result to a sending terminal of the schedule change request.

2. The management device according to claim 1, wherein
when the schedule change request is received from one of the provider terminal and the client terminal, the processor is configured to send an inquiry as to whether the schedule can be changed to the other terminal and to determine whether the schedule can be changed by further using a response to the inquiry received from the other terminal.

3. The management device according to claim 1, wherein
the processor is configured to select a transfer candidate vehicle of the package based on the package information and parking/stopping information, to inquire of a candidate terminal as to whether the package can be transferred and, when a transfer acceptance response is received from the candidate terminal, to determine that the schedule can be changed, the parking/stopping information including information on parking/stopping of a plurality of vehicles each of which can provide a vehicle cabin thereof for receiving other person's packages in the area, the candidate terminal being associated with a provider of the selected transfer candidate vehicle.

4. The management device according to claim 3, wherein
the processor is configured to select the transfer candidate vehicle by further referring to schedule information registered by providers of the plurality of vehicles.

5. The management device according to claim 3, wherein
the memory is configured to store past transfer history information and the processor is configured to select the transfer candidate vehicle by further referring to the history information.

6. The management device according to claim 3, wherein
the processor is configured to select the transfer candidate vehicle according to a type of the package.

7. The management device according to claim 3, wherein
when a transfer acceptance notification is received from the candidate terminal, the processor is configured to send a transfer instruction to a deliveryman terminal associated with a deliveryman of the package, the transfer instruction including information on the transfer candidate vehicle.

8. A management method performed by a management device including a memory and a processor having at least one piece of hardware, the management method comprising:
determining whether a schedule can be changed by reading package information from the memory when a schedule change request is received from a client terminal or a provider terminal, the client terminal being associated with a client of a delivery of a package, the provider terminal being associated with a provider of a vehicle which is parked or stopped in a predetermined area and the vehicle cabin of which is provided as a collection/delivery place of the package; and
sending a determination result to a sending terminal of the schedule change request.

9. A management program that causes a management device including a memory and a processor having at least one piece of hardware to execute:
determining whether a schedule can be changed based on package information when a schedule change request is received from a client terminal or a provider terminal, the client terminal being associated with a client of a delivery of a package, the provider terminal being associated with a provider of a vehicle which is parked or stopped in a predetermined area and the vehicle cabin of which is provided as a collection/delivery place of the package; and
sending a determination result to a sending terminal of the schedule change request.
